(19) United States
(12) Patent Application Publication
(10) Pub. No.: US 2004/0247377 A1
(43) Pub. Date: Dec. 9, 2004

(54) Device for connecting legs to furnishing elements, and a furnishing element comprising that device

(76) Inventors: Paolo Consolini, Bologna (IT); Fabio Silvestri, Modena (IT)

Correspondence Address: FLYNN THIEL BOUTELL & TANIS, P.C., 2026 RAMBLING ROAD, KALAMAZOO, MI, 49008-1699, US

(21) Appl. No.: 10/491,696

(22) PCT Filed: Oct. 4, 2002
(86) PCT No.: PCT/IB02/04092

(30) Foreign Application Priority Data
Oct. 5, 2001 (IT) BO2001A000610

(51) Int. Cl. F16B 7/10

(52) U.S. Cl. 403/83

(57) ABSTRACT

A device for connecting support legs to furnishing elements comprises a first connecting member which is to be secured to a leg, and a support unit which is to be secured to a furnishing element. The support unit comprises a second connecting member which can be selectively clamped to the first connecting member by clamping means. The first and the second connecting member comprises complementary angular-reference means which cooperate to define a plurality of predetermined orientations of the first connecting member relative to the second connecting member. In use, the clamping means engage respective clamping seats which are unequivocally determined in accordance with the orientation adopted by the first connecting member.

The present invention relates to a support device for connecting legs to furnishing elements, and to a furnishing element comprising that device. The device according to the present invention has been developed with particular, though non-limiting, regard to desks and work-tables, especially for the office, but may also be adopted for furnishing elements of a different type, for example for the support of chairs, armchairs and the like.

Various systems are known for supporting furnishing elements, and in particular for connecting support legs to work-tables, desks, chairs and the like. Depending on the dimensions, the shape and the purpose of the furnishing elements, various types of connecting device are generally adopted. Often it is also necessary to vary the position in which the devices for connecting the legs are mounted on the furnishing element.

The object of the present invention is to provide a single device for connecting support legs, which device may be usefully and advantageously employed on furnishing elements of various shapes and dimensions, without this involving a reduction in the stability of the furnishing element.

A further object of the present invention is to provide a connecting device which is simple, economical, easy to fit and which is reliable even after prolonged use.

In order to achieve the above-mentioned objects, the present invention relates to a connecting device and to a furnishing element as defined in the claims which follow.

Further characteristics and advantages of the invention will emerge from the following detailed description of a preferred embodiment, with reference to the appended drawings which are given purely by way of non-limiting example and in which:

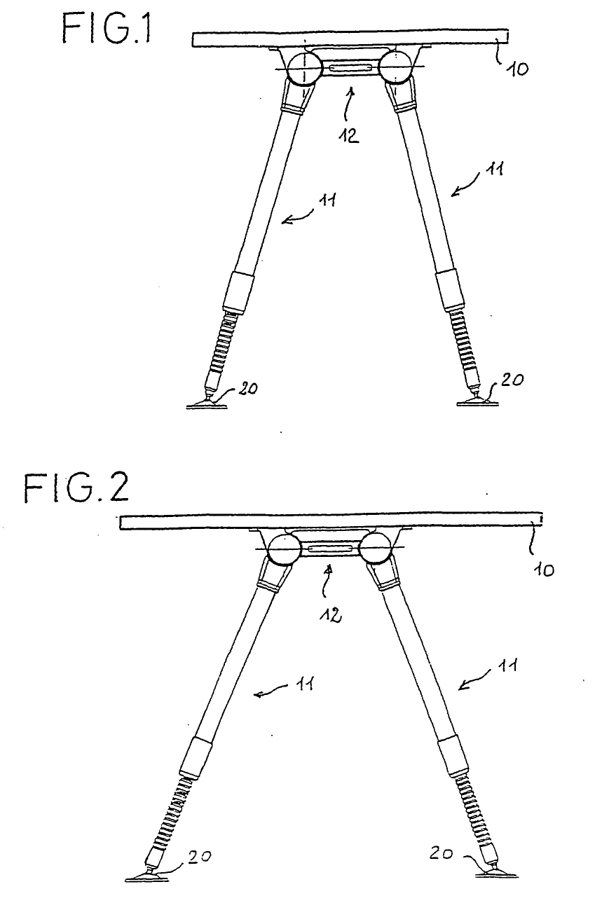

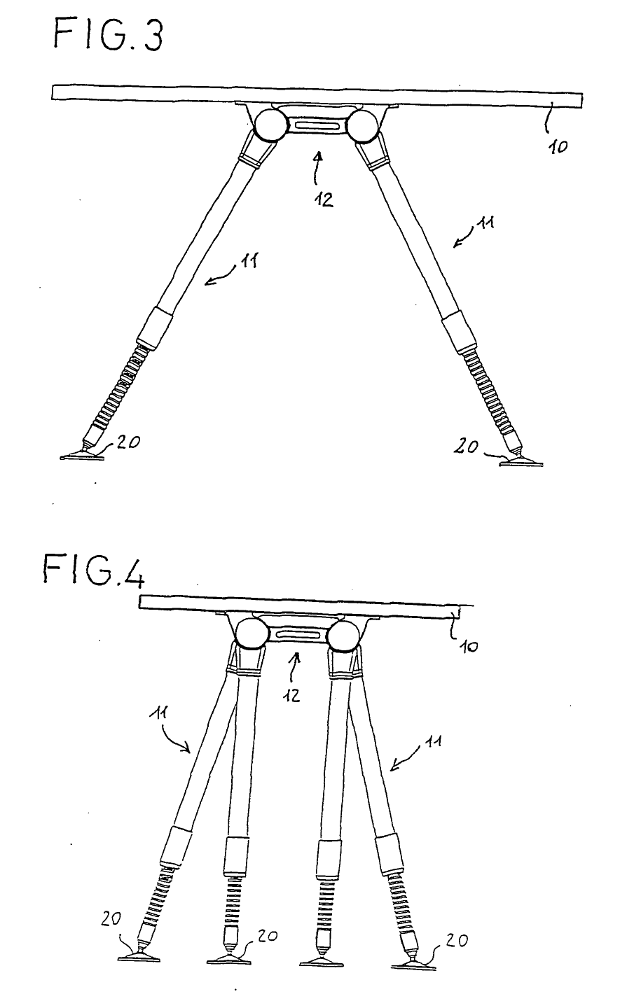

FIGS. 1, 2, 3 and 4 are side views of work-tables of various widths supported by legs which are variously inclined thanks to a connecting device according to the present invention,

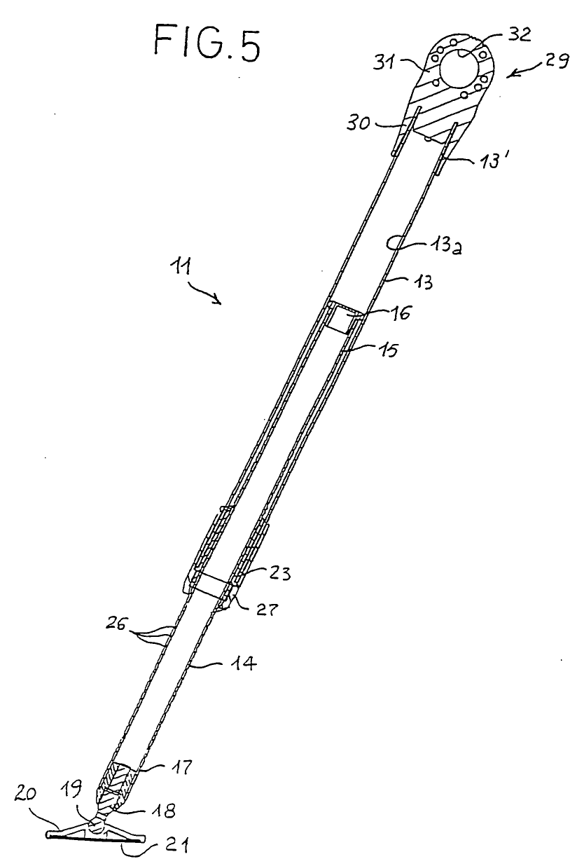

FIG. 5 is a longitudinal section through a leg according to the present invention,

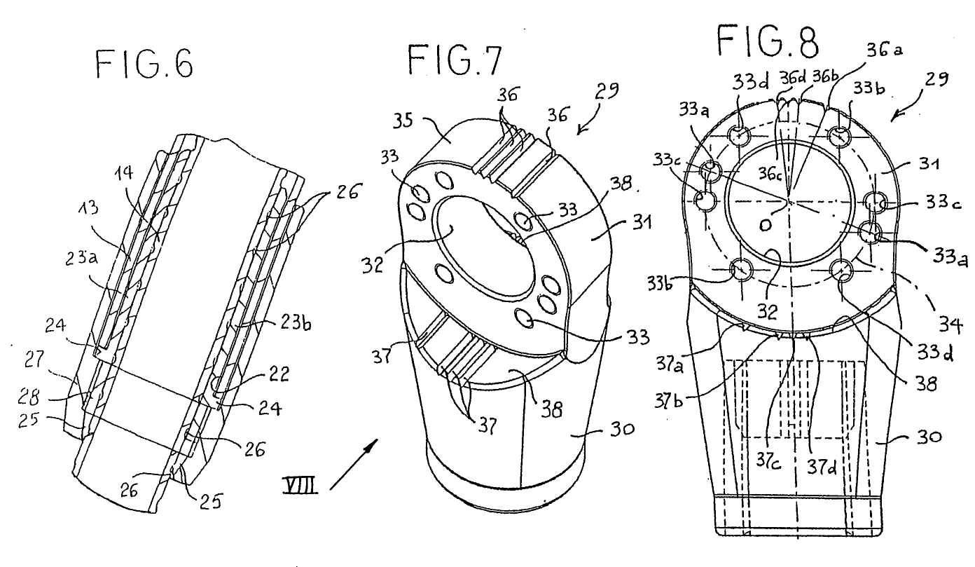

FIG. 6 is a section, on an enlarged scale, through a detail of FIG. 5 relating to the device for adjusting the length of the leg,

FIG. 7 is a perspective view of a first member of the connecting device according to the present invention,

FIG. 8 is a section taken on the line VIII-VIII of FIG. 7,

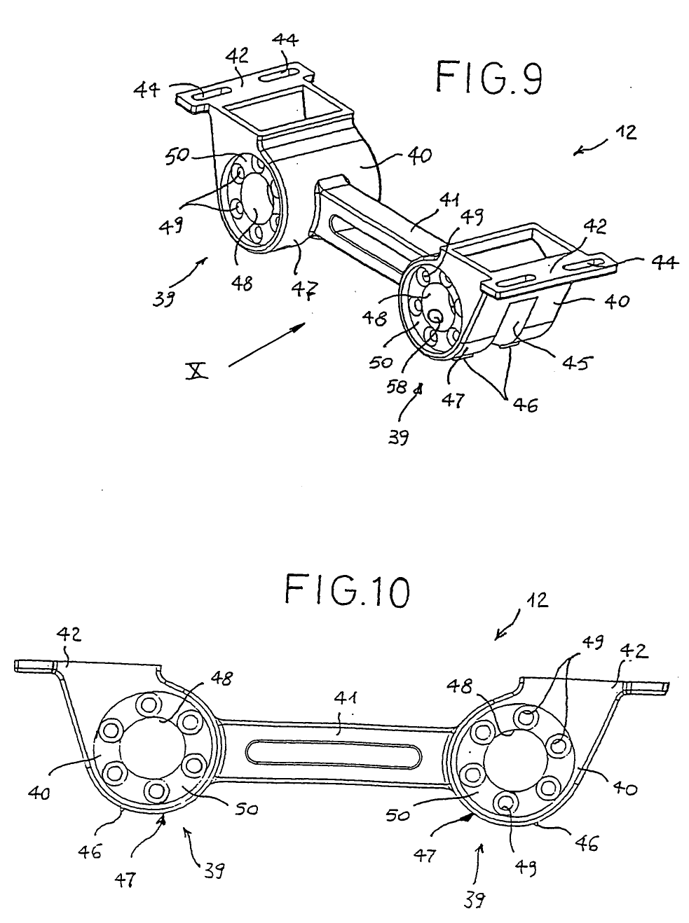

FIG. 9 is a perspective view of a second member of the connecting device according to the present invention,

FIG. 10 is a perspective view of an arrangement of work-tables supported by legs in accordance with the present invention, and

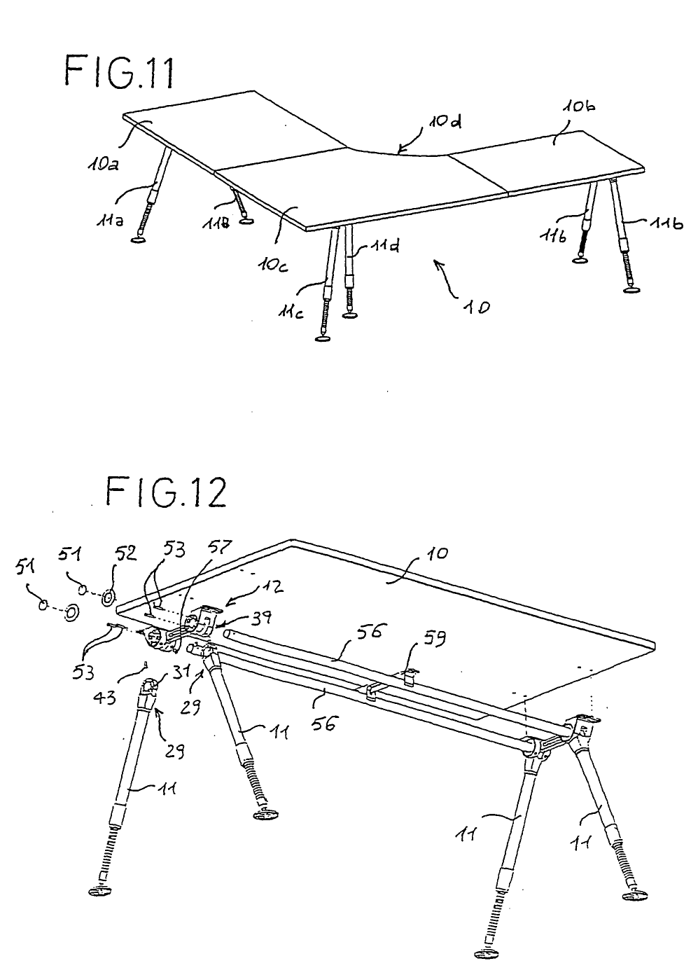

FIG. 11 is an exploded view of the elements for assembling a work-table with support legs according to the present invention.

Referring now to FIGS. 1, 2, 3 and 4, work-tables 10 of various widths are supported by legs 11 that are substantially in the form of pairs of compasses. The legs 11 are secured to support units 12 mounted in a predetermined position beneath the tables 10 and rest on the ground preferably with the interposition of feet 20. In particular, the opening of the legs 11 may assume various values in order better to support the work-tables in accordance with their width. The legs 11, as illustrated in FIG. 4, may also be disposed in an upright position.

As can be seen more clearly in FIG. 5, each leg 11 comprises a telescopic structure composed of a first, upper, tubular element 13 in which a second tubular element 14 is accommodated at least partially. A spacer plug 16 mounted slidably on the inner wall 13a of the first tubular element 13 is secured to the upper end 15 of the second tubular element 14. An appendage 18 having a spherical shank 19, in which the bearing foot 20 is engaged, preferably snap-engaged, in a mobile manner, is secured to the lower end 17 of the second tubular element 14. The engagement between the spherical shank 19 and the foot 20 permits a general freedom of orientation of the foot 20 relative to the leg 11 inside a spherical angle of determined size, so that the foot 20 can always have its lower bearing surface 21 parallel with the ground, regardless of the inclination assumed by the leg 11 within the scope of the configurations obtainable by means of the present invention.

As is shown more clearly in the detail FIG. 6, a pair of jaws 23a, 23b is arranged between the first tubular element 13 and the second tubular element 14 and has transverse ribs 24 for supporting the edges of the lower mouth 22 of the first tubular element 13, from which mouth the second tubular element 14 emerges telescopically. Each jaw 23 also has flexible appendages 25 suitable for engaging in corresponding annular grooves 26 formed in the outer surface of the second tubular element 14 at predetermined distances. A locking bush 27 can be screwed onto an outer thread 28 of the jaws 23 in order to push the flexible appendages 25 selectively into one of the grooves 26 in order to lock the tubular elements 13, 14 so as to obtain the desired length of the leg 11.

A first member 29 of the device for connecting the leg 11 to the work-table 10 is secured to the top 28 of the upper tubular element 13. As shown in detail in FIGS. 7 and 8, the above-mentioned first connecting member 29 comprises a jacket 30, inside which the upper end 29 of the leg 11 is inserted and secured, and an annular head 31 which defines a central hole 32. The annular head 31 is provided with pairs of threaded holes 33 which are centred on a common circumference 34 indicated by a dot-dash line in FIG. 8. Each pair of threaded holes 33 is arranged on diametrically opposite sides relative to the centre 0 of the central hole 32 and of the common circumference 34. In the particular, though non-limiting, example illustrated in the drawings, the annular head 31 is provided with four pairs of holes 33 which are indicated by the reference numerals 33a, 33b, 33c and 33d, respectively, in FIG. 8 and which are spaced angularly from one another in accordance with a predetermined arrangement suitable for obtaining variously inclined configurations of the legs 11, as will become clearer in the course of the present description.

Transverse notches 36 are formed in the peripheral surface 35 of the annular head 31, in a region which is substantially diametrically opposite the jacket 30, and are disposed in a predetermined angular position: four notches 36a, 36b, 36c and 36d, which are preferably V-shaped, are provided in the preferred example of FIGS. 7 and 8, and they each correspond operatively to one of the pairs of threaded holes 33a, 33b, 33c, 33d. An analogous and corresponding series of notches 37, in particular comprising four V-shaped notches 37a, 37b, 37c and 37d, is provided on at least one of two curved shoulders 38 connecting the jacket 30 to the annular head 31.

Referring now to FIGS. 9 and 10, the support units 12 comprise a pair of second connecting members 39 comprising two substantially cylindrical bodies 40 which are joined by a central beam 41 and which are provided with flanges 42 for securing them beneath the work-tables 10, in particular by means of screws 43 (see FIG. 12) passing through slots 44 formed in the flanges 42. Each second connecting member 39 is to be coupled to a corresponding annular head 31 of a corresponding first connecting member 29 of a leg 11. In particular, each cylindrical body 40 has a compartment 45 of a width substantially equal to or slightly larger than the width of the annular head 31 of the first connecting member 39. The cylindrical body 40 is provided with an outer longitudinal tooth 46 projecting from its outer surface 47, while a similar inner tooth, which cannot be seen in the drawings, projects inside the compartment 45 in a position diametrically opposite the outer tooth 46 relative to the centre of a central circular opening 48 which extends longitudinally through the cylindrical body 40. The front face 50 of the cylindrical body 40 has a plurality of through-holes 49, of which there are preferably six and which are arranged angularly at equal distances from one another around the central circular opening 48. Preferably, the region of the front face 50 in which the through-holes 49 are formed is recessed relative to the front wall of the second connecting member 39 in such a manner as to accommodate a cover 51 (see FIG. 12), which is preferably snap-fitted, and/or a covering ring 52, when the connecting device is in the mounted configuration.

The arrangement of the threaded holes 33 and the notches 36, 37 on the first connecting member 29 with respect to the arrangement of the through-holes 49 and the outer tooth 46 and the tooth inside the compartment 45 on the second connecting member 39 is such that, when the annular head 31 is inserted in the compartment 45, the outer tooth 46 and the tooth inside the compartment 45 can engage selectively in one of the notches 36, 37 in order to place a pair of threaded holes 33 in axial coincidence with a single pair of through-holes 49. In particular, depending on the particular notch 36, 37 of the annular head 31 that is engaged by the inner and outer teeth present on the second connecting member 39, only one of the pairs of threaded holes 33a, 33b, 33c, 33d will be aligned with a corresponding pair of through-holes 49 in the cylindrical body 40. By selecting the particular notch 36, 37 of the first connecting member 29 that is to be engaged by the teeth of the second connecting member 39, it is therefore possible to determine unequivocally the angulation adopted by the leg 11, and likewise readily to identify the pair of through-holes 49 into which to insert a corresponding pair of screws 53 (see FIG. 12) which can be screwed into a corresponding pair of threaded holes 33a, 33b, 33c, 33d on the annular head 31 to obtain one of the angulations of the legs 11 illustrated in FIGS. 1 to 4.

The device described above lends itself especially well to the formation of variously assembled configurations of modular work-tables 10, such as that illustrated in FIG. 11, in which a table portion 10a of greater width is supported by a pair of legs 11a which are opened to a greater extent than the pair of legs 11b which support a table portion 10b of lesser width. In addition, a central table portion 10c is supported by a central pair of legs 11c, 11d, each of which forms a different angle with the ground, the leg 11d nearest the concave work profile 10d of the table 10 being oriented vertically relative to the ground in order to avoid interference with the legs of a user seated at the work-table. The ability to adjust the legs 11 telescopically and to lock them at a desired height, together with the ability to orient the foot 20 of each leg 11, enables each portion 10a, 10b, 10c of the work-table 10 to be maintained at the same height from the ground, despite the varying inclination of the legs 11a, 11b, 11c, 11d.

Referring now to FIG. 12, in the mounted configuration for supporting a work-table 10, at least two support units 12 are secured beneath the work-table by means of, for example, the screws 53. The support units are connected to one another by stiffening bars 56 inserted into the central holes 32, 48 of the first connecting member 29 and the second connecting member 39, respectively. The stiffening bars are secured to the cylindrical bodies by pins 57 or other similar means which are screwed into radial holes 58 in the cylindrical bodies 40 and which project into the central openings 48 (see FIG. 9). The stiffening bars 56 can extend through the central holes 32, 48 or can stop with their ends at the location of a connecting unit 12. Intermediate supports 59 may be secured to the stiffening bars 56 in order to support the tables 10 in the intermediate regions between one support unit 12 and the other. In addition, furnishing accessories, such as, for example, accommodation trays for data or electrical cables, and the like may advantageously be coupled to the stiffening bars 56.

Naturally, the principle of the invention remaining the same, the details of construction and the forms of embodiment may be varied widely with respect to those described and illustrated without thereby departing from the scope of the present invention.

1. a device for connecting support legs to furnishing elements, which device comprises a first connecting member (29) which is to be secured to a leg (11), and a support unit (12) which is to be secured to a furnishing element (10), the support unit (12) comprising a second connecting member (39) which can be selectively clamped to the first connecting member (29) by clamping means (53), characterised in that the first (29) and the second connecting member (39) comprise complementary angular-reference means (33, 36, 37, 46, 49) which cooperate to define a plurality of predetermined orientations of the first connecting member (29) relative to the second connecting member (39), the clamping means (53) engaging, in use, respective clamping seats (33, 49) which are unequivocally determined in accordance with the orientation adopted by the first connecting member (29).

2. A connecting device according to claim 1, characterised in that the clamping means comprise clamping screws (53), the clamping seats comprising threaded holes (33) in the first connecting member (29) and through-holes (49) in the second connecting member.

3. A connecting device according to claim 1, characterised in that the angular-reference means comprise a plurality of notches (36, 37) formed in one of the two connecting members (29, 39), which notches are selectively engaged by at least one tooth (46) on the other connecting member (39, 29).

4. A connecting device according to claim 1, characterised in that the first connecting member (29) comprises a jacket (30) which is to be secured to a leg (11), and an annular head (31) having a central hole (32), the threaded holes (33) being formed in the annular face of the annular head (31) at a predetermined distance (34) from the centre (0) of the central hole (32), the threaded holes (33) comprising pairs of holes (33a, 33b, 33c, 33d) which are diametrically opposite one another, the pairs of holes being distributed angularly in accordance with a predetermined arrangement coordinated with the through-holes (49) in the second connecting member (39) and with the notches (36, 37) and the at least one tooth (46), a single pair of threaded holes (33a, 33b, 33c, 33d) being coaxial with a pair of through-holes (49) in each of the predetermined angular orientations of the first connecting member (29) relative to the second connecting member (39).

5. A connecting device according to claim 1, characterised in that the support unit (12) comprises two second connecting members (39) which are selectively clampable to two separate first connecting members (29).

6. A furnishing element comprising a connecting device according to claim 1, characterised in that it comprises at least one support unit (12) and a plurality of legs (11), the upper end (28) of each leg (11) being connected to a respective first connecting member (29) secured in a selectively oriented manner to an associated second connecting member (39) of the at least one support unit (12).

7. A furnishing element according to claim 6, characterised in that at least one of the legs (11) is adjustable in height.

8. A furnishing element according to claim 7, characterised in that the at least one leg (11) comprises two tubular bodies (13, 14) that are coupled telescopically.

9. A furnishing element according to claim 6, characterised in that the legs (11) comprise orientable feet (20) disposed at the opposite end relative to the first connecting member (29).

10. (Cancelled)
